(19) United States
(12) Patent Application Publication
(10) Pub. No.: US 2019/0202674 A1
(43) Pub. Date: Jul. 4, 2019

(54) INDUSTRIAL TRUCK AND DRIVE WHEEL BEARING DEVICE FOR INDUSTRIAL TRUCKS

(71) Applicant: HUBTEX MASCHINENBAU GMBH & CO. KG, FULDA (DE)

(72) Inventor: JUERGEN KELLER, GROSSENLUEDER (DE)

(73) Assignee: HUBTEX MASCHINENBAU GMBH & CO. KG, FULDA (DE)

(21) Appl. No.: 16/328,727

(22) PCT Filed: Jul. 26, 2017
(86) PCT No.: PCT/EP2017/068928

§ 371 Date: Feb. 27, 2019

(30) Foreign Application Priority Data
Sep. 2, 2016 (DE) 10 2016 116 469.0
Feb. 15, 2017 (DE) 10 2017 103 024.7

(51) Int. Cl. B66F 9/075

(52) U.S. Cl. CPC B66F 9/07572; B60Y 2200/15; B66F 9/07513; B66F 9/07586

(57) ABSTRACT

An industrial truck include a chassis with bearing points, two drive wheel arrangements each having a drive wheel, a guide arrangement for each drive wheel arrangement, and a hydraulic piston-cylinder unit for each drive wheel arrangement. The guide arrangement includes at least two connecting rods each having a first end and a second end, a coupler having a first side, a second side, and coupler bearing points, and a guide direction component which extends approximately perpendicular to a plane of the chassis. Each connecting rod is arranged so that the first end is on a chassis bearing point and the second end is on a coupler bearing point. Each piston-cylinder unit is connected on a piston side to the chassis and on a cylinder side to a drive wheel arrangement or vice versa. A cylinder volume of each piston-cylinder unit is hydraulically connected to each another.

The invention relates to an industrial truck having a chassis or running gear, which defines a plane, which is also referred to as a base plane and extends approximately parallel to the underlying surface in an operating position of the industrial truck, and having at least two drive arrangements each having at least one drive wheel. Furthermore, the invention relates to a drive wheel bearing device for an industrial truck.

Such industrial trucks are known in a variety of embodiments depending on the field of use. They are often used for raising and lowering products, for example, for storage in or removal from rack systems, for which purpose they then generally have a lifting mast extending approximately vertically from the chassis—also called running gear or frame—along which the products can be raised or lowered using suitable means. Since the individual configuration of such an industrial truck has no influence on the invention in the present case, it will not be described in greater detail. Rather, the configuration of the industrial truck can be a configuration known per se.

In addition to the at least two drive wheel arrangements, industrial trucks often comprise two or more load wheels, which can be arranged on the chassis so that the weight forces acting from the loads to be transported on the chassis are introduced in a substantial part into the underlying surface via these load wheels.

To be able to compensate for irregularities of the underlying surface, providing the drive wheel arrangements on a pendulum frame is known. This pendulum frame is then linked to the chassis so it can be tilted around a floating axle, which extends approximately perpendicularly to a connecting line of the two drive wheel arrangements and approximately in the middle between them.

Such industrial trucks, the drive wheel arrangements of which are provided on a pendulum frame, have the disadvantage that the running wheel surfaces are loaded unevenly in the event of irregularities. The tread wear can thus be increased and the adhesive friction on the underlying surface can be reduced. Furthermore, industrial trucks which are designed having such pendulum frames can tend toward rocking movements, which can be a significant disadvantage in particular in the case of taller lifting masts.

The object of the present invention is therefore to provide an industrial truck and a drive wheel bearing device which each improve at least one of the above-mentioned disadvantages and in particular enable movement of the industrial truck nearly without jerking and rocking.

This object is achieved by an industrial truck having the features of claim 1 and by a drive wheel bearing device having the features of claim 16. Advantageous embodiments and refinements of the invention are disclosed in the dependent claims, the description, and the figures.

The industrial truck according to the invention comprises at least one guide arrangement for each drive wheel arrangement. The guide arrangement can effectuate, for example, a vertical displacement of the drive wheel arrangement and provides either a linear guide or a—for example, curved—guide path each having a main guide direction component which extends approximately perpendicularly to the base plane. The respective drive wheel arrangement is displaceable, for example, vertically displaceable, along this linear guide or guide path.

In the first embodiment according to the invention, which relates to a guide arrangement providing a linear guide, for example, a rail or profile system, along which the drive wheel arrangement is displaceable, can be provided for guiding and displacing the drive wheel arrangement. Rocking movements of the industrial truck can thus be avoided and particularly large load forces can also be absorbed on the drive wheels, in addition to the load wheels, so that the industrial truck can have a particularly large maximum payload.

In the alternative second embodiment according to the invention, which relates to the guide arrangement providing a guide path, the guide arrangement according to the invention has at least two, preferably three, connecting rods each having a first end and a second end, and also a first coupler having a first side and a second side. The connecting rods—also called transverse struts—are each linked or mounted with the first end thereof on a bearing point arranged on the chassis and with the second end thereof on a bearing point arranged on the first side of the coupler, in each case so they are pivotable around preferably parallel axes of rotation. The bearing points arranged on the chassis are also referred to in the present case as first, second, and third bearing points, and the bearing points arranged on the coupler as fourth, fifth, and sixth bearing points. The bearing points are preferably designed in such a way that the axes of rotation extend parallel to the plane. Due to the pivot along the guide path, tilts in relation to the chassis can be avoided and also the tread load of the drive wheels can be advantageously distributed uniformly.

Furthermore, the industrial truck according to the invention comprises at least one, preferably hydraulically acting piston-cylinder unit per drive wheel arrangement. Each piston-cylinder unit has a piston side and a cylinder side and also at least one first cylinder volume or, in other words, a first cylinder volume chamber. Each piston-cylinder unit is connected using the piston side or using the cylinder side to the chassis and using the respective other piston side or cylinder side to the drive wheel arrangement. At least a part of the approximately vertical forces acting from the chassis on the respective drive wheel arrangement can thus be introduced via at least one preferably hydraulically acting piston-cylinder unit into the respective drive wheel arrangement. In the embodiment according to the invention having multiple drive wheel arrangements and therefore multiple piston-cylinder units, the first cylinder volumes, i.e., the respective first cylinder volume chambers, of the piston-cylinder units are preferably hydraulically connected to one another, so that a retraction of one drive wheel arrangement, i.e., a displacement thereof upward in relation to the chassis, results in an extension of the other drive wheel arrangement, i.e., in a displacement downward in relation to the chassis (each in relation to the upright operating position of the industrial truck). As a result of the preferably hydraulic coupling, the load of the drive wheel arrangements and in particular the treads is furthermore evened out and the tendency of the industrial truck to rock is reduced.

The piston-cylinder unit is preferably arranged in such a way that an action direction of the piston-cylinder unit, i.e., a displacement direction of the piston inside the cylinder, extends approximately perpendicularly to the plane. Each of the piston-cylinder units is preferably arranged and/or designed in such a way that it can be loaded on hydraulic pressure because of the weight forces to be absorbed. In particular, the piston-cylinder unit can be arranged essentially upright or vertical on a drive wheel arrangement in the operating position of the industrial truck, so that a weight force component can be introduced into the piston-cylinder unit and therefore the piston-cylinder unit, in particular a hydraulic pressure in the cylinder volume can absorb, for example, a load weight. The industrial truck—in spite of the essentially vertically-displaceable drive wheel arrangement—can thus also transport particularly heavy loads.

The piston-cylinder units are preferably each designed as single-action. This means, for example, that in each case only one of the piston-side and piston-rod-side volumes, preferably only the piston-side volume, is hydraulically connected to one another. A restoring force of the piston can thus be produced, for example, by the hydraulic pressure equalization or, for example, by a restoring spring element.

At least one piston-cylinder unit preferably additionally has a second cylinder volume or, in other words, an additional second cylinder volume chamber. At least two piston-cylinder units particularly preferably each additionally have a second cylinder volume, wherein these two second cylinder volumes can be connected to one another. The operational reliability of the industrial truck can thus be enhanced, by the respective second cylinder volumes preferably also being hydraulically connected to one another—as is particularly preferred. In other words, this measure has the effect that two hydraulic systems independent of one another are provided:
a first hydraulic system, which comprises the first cylinder volumes and the means preferably hydraulically connecting them, and
a second hydraulic system, which comprises the second cylinder volumes and the means preferably hydraulically connecting them.
   The functionality that the displacements of the drive wheel arrangements in relation to the chassis are independent of one another is thus maintained even for the case in which one of the two hydraulic systems has a leak.

The guide arrangement providing a linear guide or alternatively a guide path is preferably designed in such a way that at least a part, preferably the substantial part of the drive, braking, and/or steering forces can be introduced via it from the respective drive arrangement into the chassis. As a result of this “assisting” measure, substantial forces going beyond the weight forces are prevented from being introduced predominantly via the piston-cylinder unit from the chassis into the drive wheel arrangements, so that the influence of drive, braking, and/or steering forces on the attitude of the vehicle in relation to the underlying surface is minimized.

In the variant of the guide arrangement providing a guide path, the respective drive wheel arrangement is preferably connected to the second side of the coupler. The connection of the two components can be produced, for example, via a connecting element, the second side of the coupler is particularly preferably arranged directly on the drive wheel arrangement or on a drive wheel bearing structure of the drive wheel arrangement. As a result of this measure, a larger installation space of a vehicle can be provided for the drive wheel arrangement than would be possible if the respective drive wheel arrangement were connected to the first side of the coupler.

In the case of the guide arrangement providing a guide path, at least two of the bearing points arranged on the chassis and at least two of the bearing points arranged on the coupler are preferably each arranged on a straight line extending approximately perpendicularly to the plane. If—as preferred—in addition to the bearing points arranged on the chassis, the bearing points arranged on the coupler are also arranged on a straight line extending approximately perpendicularly to the plane, which can be effectuated, for example, if the connecting rods have at least approximately identical lengths proceeding from an arrangement of the bearing points arranged on the chassis to a straight line extending perpendicularly to the plane, the respective drive arrangement—with the exception of a movement component parallel to the plane in dependence on the length of the coupler—thus advantageously executes essentially only the guide direction component perpendicular to the plane. A total of three connecting rods each mounted using a first end on a bearing point arranged on the chassis and using a second end on a bearing point arranged on a first side of the coupler are particularly preferably provided, wherein at least two of the bearing points arranged on the chassis, for example, the first and second bearing points, are arranged on a first straight line extending approximately perpendicularly to the base plane and the third bearing point is preferably arranged offset from this first straight line extending approximately perpendicularly to the base plane in a direction facing away from the drive wheel arrangement, and at least two of the bearing points arranged on the coupler, for example, the fourth and fifth bearing points, are arranged on a second straight line extending approximately perpendicularly to the base plane and the sixth bearing point is preferably arranged offset from this first straight line extending approximately perpendicularly to the base plane in a direction facing toward the connecting means. The distance between the third bearing point arranged offset and the first straight line particularly preferably corresponds to the distance between the sixth bearing point arranged offset and the second straight line. A particularly secure guide on the guide arrangement can thus be ensured.

The connecting rods provided in the guide arrangement providing a guide path are preferably always arranged parallel to one another. A particularly secure guide on the guide arrangement can thus advantageously be ensured.

It is preferably provided in the guide arrangement providing a linear guide that each linear guide arrangement comprises at least one guide element. The guide element can be designed, for example, as a rail system or profile system known per se for the linear guiding of two components in relation to one another. Each guide element is preferably connected to the chassis at two bearing points, which are separate in particular. A particularly secure guide on the guide arrangement can thus be ensured in an advantageous manner. To effectively avoid problems as a result of a statically overdetermined mounting, one of the bearing points is preferably designed as a fixed bearing and the other of the bearing points is preferably designed as a floating bearing. The forces acting in the guide direction on the respective guide element are then introduced via only one of the bearing points into the chassis.

Each drive wheel arrangement preferably comprises a rotational drive motor coupled to the respective at least one drive wheel. In this case, this can be in particular a hydraulically or electrically operated rotational drive motor.

In addition, it is particularly preferable if each rotational drive motor is arranged so it is displaceable with the drive wheel arrangement in the guide direction. In particular complex connections enabling relative displacements between the drive wheels and the respective drive wheel motors can thus be saved.

The drive wheel bearing device according to the invention for industrial trucks essentially comprises a support structure for an assembly of a drive wheel which is vertically adjustable in relation to a chassis. For this purpose, the drive wheel bearing device according to the invention has a first fastening region formed substantially parallel to the base plane and a separate second fastening region arranged substantially perpendicular to the base plane. A wheel suspension structure which extends longitudinally essentially perpendicularly to the plane and is rotatably mounted in relation to the support structure is fastened on the first fastening region. At least one drive wheel having a main axis of rotation arranged substantially parallel to the plane and at least one drive motor for driving and/or pivoting the drive wheel in relation to the support structure are arranged on the wheel suspension structure. The main rotational axis of this drive motor is preferably arranged substantially perpendicularly to the base plane. Means for fastening the support structure on a chassis are arranged on the second fastening region. These means are preferably used for a vertically-adjustable mounting of the support structure in relation to the chassis and can be in particular a component of the above-described guide arrangement. The means are, for example, part of the above-described linear guide arrangement, for example, a guide rail. Alternatively, the means are, for example, bearing points arranged one over another, such as bolts mounted in boreholes, on which the above-described connecting rods can be mounted on the drive wheel side in the case of the guide arrangement providing a guide path. The drive wheel bearing device or the drive wheel arrangement can thus be configured in a particularly space-saving manner and can be particularly effective in its functionality even with very large load absorption forces.

The invention will be explained further hereafter on the basis of the appended, solely schematic drawings. In the schematic figures:

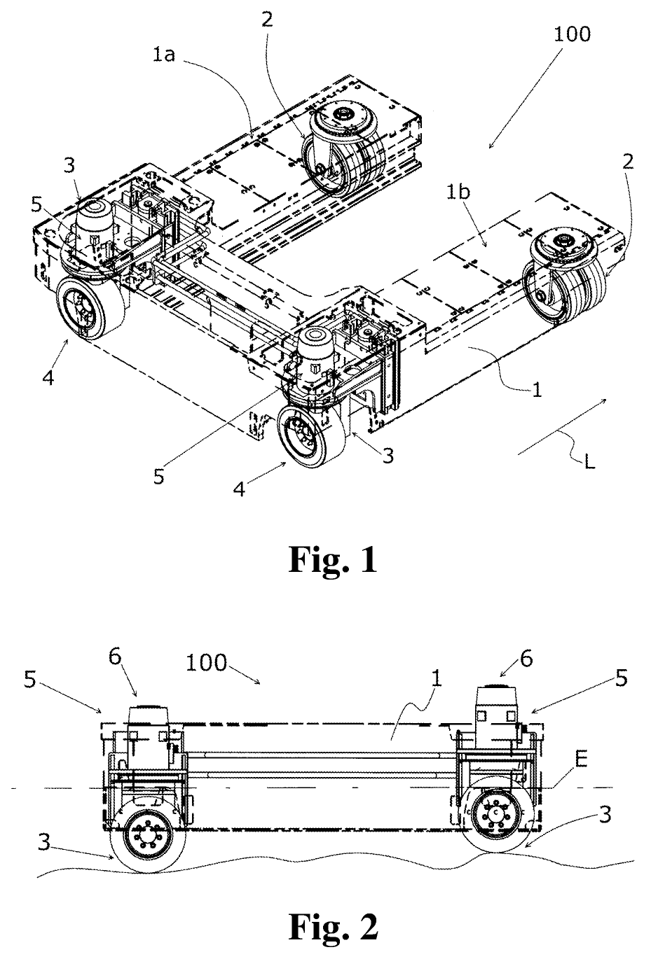

FIG. 1 shows an industrial truck according to the invention without add-ons in a perspective illustration;

FIG. 2 shows a driving situation of the industrial truck from FIG. 1;

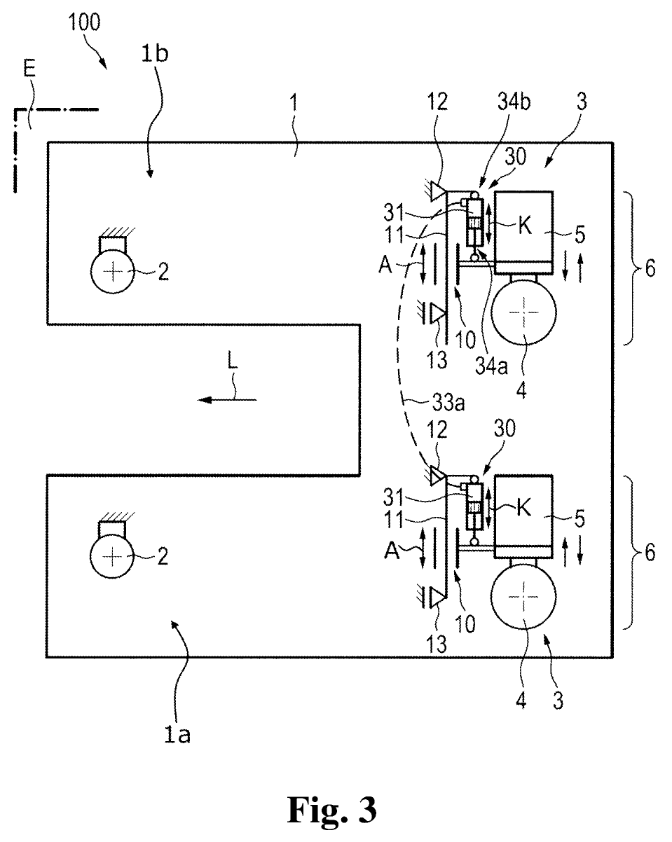

FIG. 3a shows a first embodiment of the industrial truck having a linear guide arrangement in a schematic sketch;

FIGS. 3b and 3c each show the two drive wheel arrangements from FIG. 3a in different driving situations in a schematic sketch;

FIGS. 3d, 3e, 3f each show a side view of a drive wheel arrangement having a linear guide arrangement in different positions;

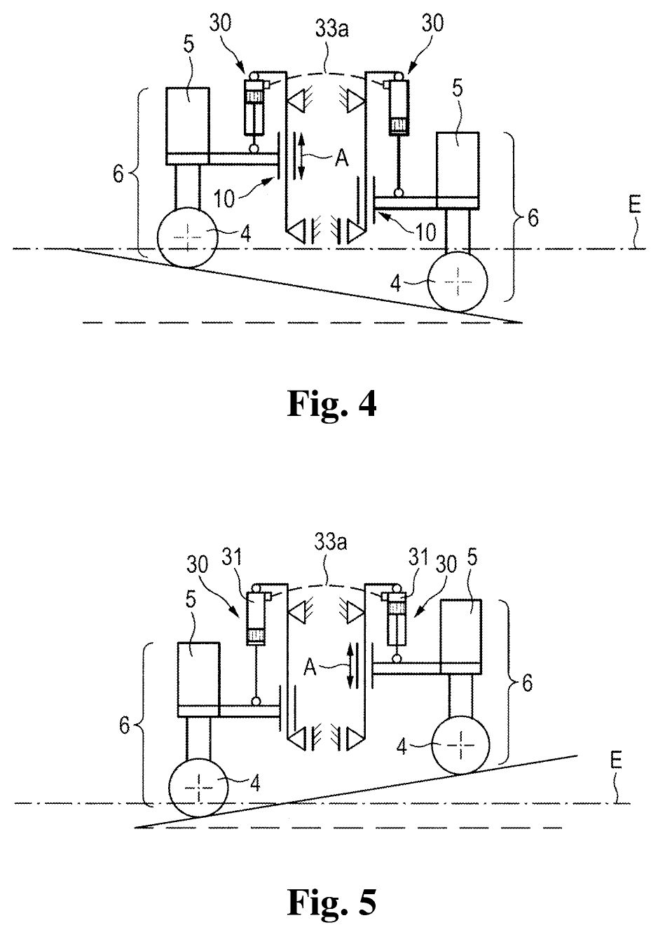

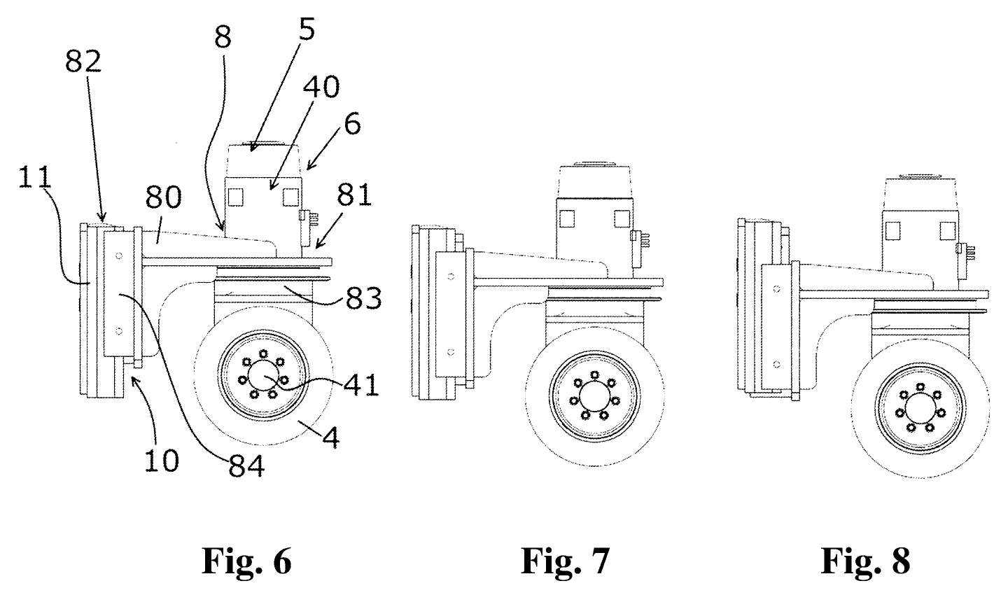

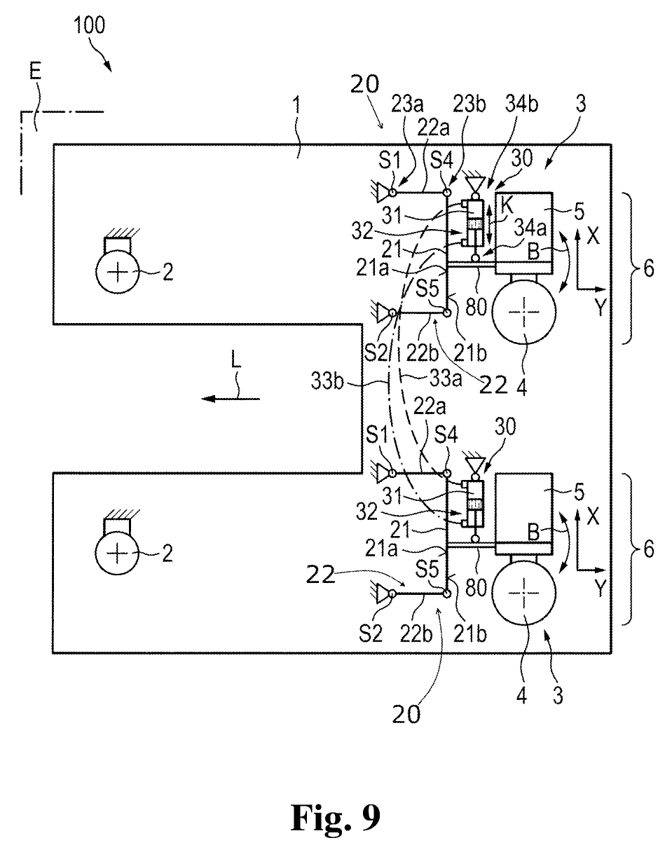

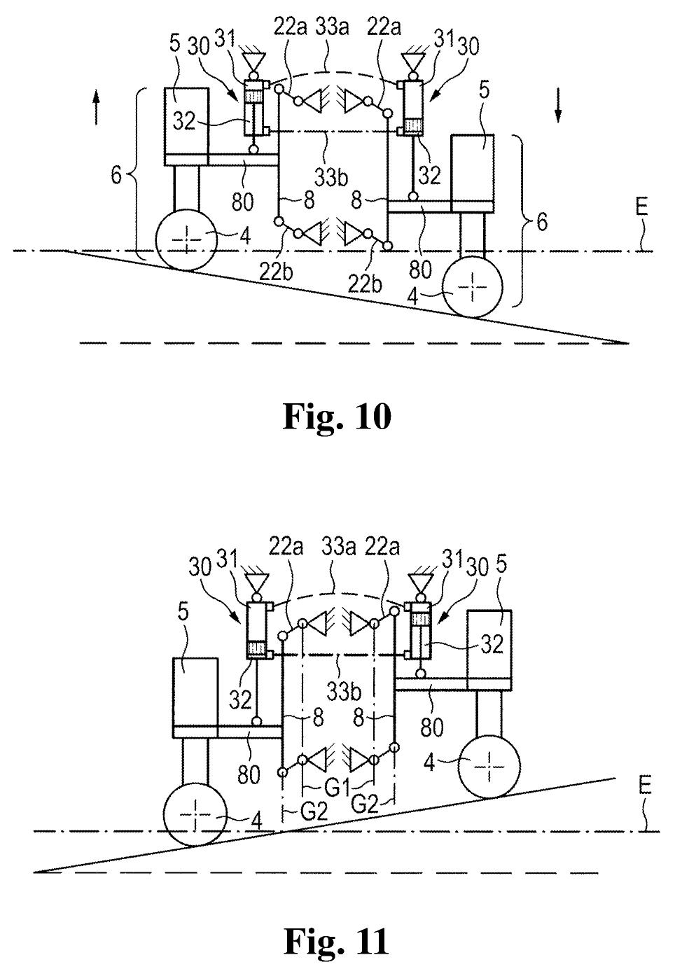

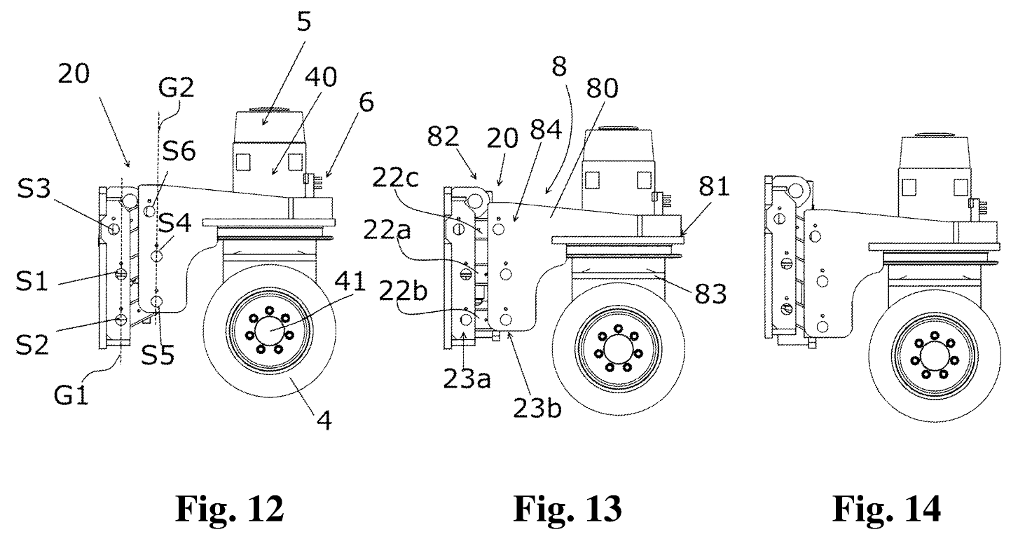

FIG. 4a shows a second embodiment of the industrial truck having a curved guide arrangement in a schematic sketch;

FIGS. 4b and 4c each show the two drive wheel arrangements from FIG. 4a in different driving situations in a schematic sketch; and

FIGS. 4d, 4e, 4f each show a side view of the drive wheel arrangement having an expanded curved guide arrangement in different positions.

The industrial truck according to the invention, which is identified with 100 in each of the figures, comprises a chassis 1, which defines a plane E extending approximately parallel to an underlying surface. As is recognizable in FIG. 1 in particular, a load pickup unit (not shown) can be arranged in the region of the chassis 1 in which the chassis has two leg structures 1a, 1b. Two non-driven load wheels 2 are provided in this region. Two drive wheel arrangements 3 are provided on the chassis 1 spaced apart from the load wheels 2 with respect to a longitudinal travel direction L. Each drive wheel arrangement 3 comprises a drive wheel 4, which is rotationally drivable by means of an in particular electrically or hydraulically driven rotational drive motor 5.

The drive wheel 4 and the drive wheel motor 5 are combined to form an assembly 6, which is mounted on the chassis 1 by means of a guide arrangement 10, 20 acting approximately perpendicularly to the plane E. The assembly 6 can be designed as a drive wheel bearing device 8, which has a support structure 80, which has a first fastening region 81 formed substantially parallel to the plane E and a separate second fastening region 82 arranged substantially perpendicular to the plane E. A wheel suspension structure 83 extending substantially perpendicular to the plane E and rotatably mounted in relation to the support structure 80 is arranged on the first fastening region 81. At least the one drive wheel 4 having a main axis of rotation 41 arranged substantially parallel to the plane E and at least one drive motor 5, 40 for the drive, in particular for a rotation about a main axis of rotation 41, and/or for the pivot of the drive wheel 4 in relation to the support structure 80 about an axis arranged perpendicular to the plane E is arranged on the wheel suspension structure 83. For example, the drive motor 5 is used for steering and the drive motor 40 is used for driving the industrial truck 100. The second fastening region 82 in particular has means 84 for fastening the support structure 80 on a chassis 1.

The entire assembly 6 is attached to the chassis 1 via the guide arrangement 10, 20 so it is displaceable in each case substantially perpendicular to the plane E, which is recognizable, for example, in FIG. 2. In this case, the drive wheel 4 shown on the left in FIG. 2 is extended farther in relation to the chassis than the drive wheel 4 shown on the right in FIG. 2. A hydraulic piston-cylinder unit 30, which is connected at one end 34b to the chassis 1 and at the other end 34a to the drive wheel arrangement 3 or the support structure 80, is provided for each assembly 6 for absorbing a weight force and/or for supporting the drive wheel arrangement 3 in relation to the chassis 1.

In a first embodiment according to the invention, the guide arrangement 10, as shown in FIGS. 3a to 3f, is configured as a linear guide arrangement, comprising a guide element 11, which is attached at two bearing points 12, 13 to the chassis 1. The bearing point 12 is designed as a fixed bearing, the bearing point 13 is designed as a floating bearing, to avoid a static overdetermination.

The guide element 11 is designed in the present case as a component of a rail system, in which a sliding element is provided, which is arranged on the drive wheel arrangement 3 and is linearly displaceable on the guide element 11 designed as a rail. In this case, the entire drive wheel arrangement 3 or assembly 6, comprising the drive wheel 4 and the rotational drive motor 5, is mounted so it is displaceable along the rail 11 in the direction A, in particular vertically displaceable, which is shown in particular in the embodiment illustrated in FIGS. 3d, 3e, and 3f.

The two piston-cylinder units 30 shown by way of example in FIGS. 3a, 3b, and 3c for supporting the drive wheel arrangement 3 in relation to the chassis 1 each comprise a first cylinder volume 31, which are hydraulically connected to one another via a first line 33a, which acts at least essentially without a throttle. A hydraulic medium can thus be pressed from the first cylinder volume 31 of the one piston-cylinder unit 30 into the first cylinder volume 31 of the other piston-cylinder unit 30 depending on the existing irregularity.

In a second embodiment according to the invention, the guide arrangement 20, which is illustrated in detail in FIGS. 4a to 4f, is designed as a curved guide arrangement. This curved guide arrangement 20 essentially comprises a coupler 21 pivotably mounted on the assembly 6 and also multiple connecting elements or connecting rods 22, which connect the coupler 21 to the chassis 1 and are also pivotably mounted.

In the embodiment shown in FIGS. 4a, 4b, and 4c, a total of two connecting elements 22 are provided in each case per drive wheel arrangement 3, namely a first connecting rod 22a and a second connecting rod 22b. In the expanded or modified embodiment shown in FIGS. 4d, 4e, and 4f, a total of three connecting elements 22 are provided per drive wheel arrangement 3, namely a first connecting rod 22a, a second connecting rod 22b, and a third connecting rod 22c. Depending on the embodiment, the connecting rods 22a, 22b, 22c are each mounted with a first connecting rod end 23a on a respective first bearing point S1, S2, S3 so they are pivotable about an axis of rotation parallel to one another on the chassis 1 and with an opposing second connecting rod end 23b on a respective second bearing point S4, S5, S6 so they are pivotable about axes of rotation parallel to one another on a first side 21a of a coupler 21. The coupler 21 is connected to a support structure 80 having the assembly 6 on a second side 21b of the coupler 21 opposite to the first side 21a.

Two of the first bearing points, namely bearing points S1 and S2, are located on a straight line G1, the optional additional third first bearing point S3 is arranged offset in relation to the straight line G1, which is shown in particular in FIGS. 4d, 4e, 4f. Two of the second bearing points, namely bearing points S4 and S5, are also located on a straight line G2, the optional additional third second bearing point S6 is arranged offset in relation to the straight line G2. The two straight lines G1 and G2 extend approximately perpendicular to the plane E and parallel to one another.

The assembly 6 is thus mounted along a guide path B, which comprises a movement component X perpendicular to the plane E and a movement component Y parallel to the plane E. The coupler 21 and the connecting rods 22a, 22b, 22c thus form the main component of the curved guide arrangement 20.

The two piston-cylinder units 30 shown by way of example in FIGS. 4a, 4b, and 4c each comprise, in addition to the first cylinder volume 31, which are hydraulically connected to one another via a first line 33a, additionally a second cylinder volume 32, which are hydraulically connected to one another via a second line 33b. The lines 33a, 33b can be substantially throttle-free or can also be provided with preferably adjustable throttles. A hydraulic medium can thus be pressed, depending on the irregularity present, from the first cylinder volume 31 of a first piston-cylinder units 30 into the first cylinder volume 31 of a second piston-cylinder unit 30 and from the second cylinder volume 32 of the second piston-cylinder units 30 into the second cylinder volume 32 of the first piston-cylinder units 30, as shown, for example, in FIGS. 2, 4b, and 4c. Particularly reliable operation of the hydraulic system is thus enabled, for example, the hydraulic pressure can be distributed uniformly onto both hydraulic lines.

The functionality of the vehicle 100 according to the invention will now be explained further for each of the above-mentioned embodiments on the basis of FIGS. 3a and 3b, and also 4a and 4b.

If the drive wheel 4 shown on the left in the viewing direction according to FIG. 3a is displaced upward by an underlying surface irregularity, for example, the reduction of the first cylinder volume 31 of the left piston-cylinder unit 30 linked thereto thus has the result that hydraulic medium is pressed via the first line 33a at least essentially without a throttle into the first cylinder volume 31 of the piston-cylinder unit 30 shown on the right in FIG. 3a and the assembly 6 having the drive wheel 4 shown on the right is thus displaced downward. Of course, this procedure only takes place when the drive wheel 4 shown on the left in FIG. 3a) is loaded more strongly than the drive wheel 4 shown on the right. A reversed movement sequence with reversed load conditions is shown accordingly in FIG. 3b.

If the drive wheel 4 shown on the left in the viewing direction according to FIG. 4a is displaced upward by an underlying surface irregularity, for example, the reduction of the first cylinder volume 31 and enlargement of the second cylinder volume 32 linked thereto of the piston-cylinder unit 30 illustrated on the left has the result that a hydraulic medium is pressed via the first hydraulic line 33a into the first cylinder volume 31 of the piston-cylinder unit 30 shown on the right in FIG. 4a) and a hydraulic medium is pressed from the second cylinder volume 32 in the piston-cylinder unit 30 shown on the right into the second cylinder volume 32 of the piston-cylinder unit 30 shown on the left via the second line 33b and thus the assembly 6 having the drive wheel 4 shown on the right is displaced downward. Of course, this procedure only takes place when the drive wheel 4 shown on the left in FIG. 4a) is loaded more strongly than the drive wheel 4 shown on the right. A reversed movement sequence with reversed load conditions is shown accordingly in FIG. 4b).

It should be clear that the scope of protection of the present invention is not limited to the exemplary embodiments described. In particular the configuration of the industrial truck and the type of the chassis can certainly be modified—without changing the core concept of the invention. It is also to be noted once again that the figures, in particular the schematic sketches, solely illustrate the relationship schematically to visualize the invention. Thus, for example, neither size ratios nor axial alignments of the individual wheels illustrated in the schematic sketches correspond to reality.

### LIST OF REFERENCE NUMERALS

100 industrial truck
1 chassis, running gear, frame, undercarriage
1a leg structure
1b leg structure
2 load wheels
3 drive wheel arrangement
4 drive wheel
5 rotational drive motor
6 assembly
8 drive wheel bearing device
10 guide arrangement, linear guide arrangement
11 guide element
12 bearing point
13 bearing point
20 guide arrangement, guide path arrangement
21 coupler
21a first side
21b second side
22 connecting element, connecting rod
22a connecting rod
22b connecting rod
22c connecting rod
23a first connecting rod end
23b second connecting rod end
30 piston-cylinder unit
31 first cylinder volume
32 second cylinder volume
33a first line
33b second line
33c third line
34a piston side
34b cylinder side
40 drive motor
41 main axis of rotation
80 support structure
81 first fastening structure
82 second fastening structure
83 wheel suspension structure
84 means for fastening
A linear guide
B guide path
E plane
G1 straight line
G2 straight line
K action direction of piston-cylinder unit
L longitudinal travel direction
S1 first bearing point
S2 second bearing point
S3 third bearing point
S4 fourth bearing point
S5 fifth bearing point
S6 sixth bearing point
X guide direction component
Y guide direction component

1-15. (canceled)

16. An industrial truck comprising:
a chassis which defines a chassis plane which extends approximately parallel to an underlying surface in an operating position of the industrial truck, the chassis comprising chassis bearing points arranged thereon;
at least two drive wheel arrangements, each of which comprise at least one drive wheel;
at least one guide arrangement for each of the at least two drive wheel arrangements which is configured to provide a guide path along which each of the at least two drive wheel arrangements are displaceable, the at least one guide arrangement comprising,
at least two connecting rods each of which comprise a first end and a second end,
a coupler comprising a first side, a second side, and coupler bearing points arranged thereon, and
a guide direction component which extends approximately perpendicular to the chassis plane,
wherein,
each of the at least two connecting rods are arranged so that the first end is arranged on one of the chassis bearing points and the second end is arranged on one of the coupler bearing points and to extend away from the first side; and
a piston-cylinder unit which is configured to act hydraulically for each of the at least two drive wheel arrangements, each piston-cylinder unit comprising,
a piston side,
a cylinder side, and
a first cylinder volume,
wherein,
each piston-cylinder unit is connected on the piston side to the chassis and on the cylinder side to the one of the at least two drive wheel arrangements or is connected on the piston side to one of the at least two drive wheel arrangements and on the cylinder side to the chassis, and
the at least one first cylinder volume of each piston-cylinder unit is hydraulically connected to one another.

17. The industrial truck as recited in claim 16, wherein each piston-cylinder unit is arranged so that an action direction of the respective piston-cylinder unit extends approximately perpendicular to the chassis plane.

18. The industrial truck as recited in claim 16, wherein at least one piston-cylinder unit is designed as a single-action piston-cylinder unit.

19. The industrial truck as recited claim 16, wherein at least one piston-cylinder unit comprises a second cylinder volume.

20. The industrial truck as recited in claim 19, wherein,
at least two piston-cylinder units each comprise a respective second cylinder volume, and
the second cylinder volumes are hydraulically connected to one another.

21. The industrial truck as recited in claim 16, wherein the at least one guide arrangement is designed so that at least a part of at least one of a driving force, a braking force, and a steering force is/are introduced via the at least one guide arrangement into the chassis.

22. The industrial truck as recited in claim 16, wherein each of the at least two drive wheel arrangements are connected to the second side of the coupler to provide the guide path.

23. The industrial truck as recited in claim 16, wherein at least two of the chassis bearing points and at least two of the coupler bearing points are each arranged on a straight line which extends approximately perpendicular to the chassis plane.

24. The industrial truck as recited in claim 16, wherein each of the at least two connecting rods are always arranged parallel to one another.

25. The industrial truck as recited in claim 16, wherein each of the at least two drive wheel arrangements further comprises a rotational drive motor which is coupled to the respective at least one drive wheel.

26. The industrial truck as recited in claim 25, wherein the rotational drive motor is arranged so as to be displaceable with the respective drive wheel arrangement along the guide path.

27. An industrial truck comprising:
a chassis which defines a chassis plane which extends approximately parallel to an underlying surface in an operating position of the industrial truck, the chassis comprising chassis bearing points arranged thereon;
at least two drive wheel arrangements, each of which comprise at least one drive wheel;
at least one guide arrangement for each of the at least two drive wheel arrangements which is configured to provide a linear guide along which the at least two drive wheel arrangements are each displaceable, the at least one guide arrangement comprising at least one guide element; and
a piston-cylinder unit which is configured to act hydraulically for each of the at least two drive wheel arrangements, each piston-cylinder unit comprising,
a piston side,
a cylinder side, and
a first cylinder volume,
wherein,
each piston-cylinder unit is connected on the piston side to the chassis and on the cylinder side to the one of the at least two drive wheel arrangements or is connected on the piston side to one of the at least two drive wheel arrangements and on the cylinder side to the chassis, and
the at least one first cylinder volume of each piston-cylinder unit is hydraulically connected to one another.

28. The industrial truck as recited in claim 27, wherein each piston-cylinder unit is arranged so that an action direction of the respective piston-cylinder unit extends approximately perpendicular to the chassis plane.

29. The industrial truck as recited in claim 27, wherein at least one piston-cylinder unit is designed as a single-action piston-cylinder unit.

30. The industrial truck as recited in claim 27, wherein the at least one guide arrangement is designed so that at least a part of at least one of a driving force, a braking force, and a steering force is/are introduced via the at least one guide arrangement into the chassis.

31. The industrial truck as recited in claim 27, wherein the at least one guide element is connected at two chassis bearing points to the chassis in a guide direction.

32. The industrial truck as recited in claim 31, wherein the two chassis bearing points comprise a first bearing point which is designed as a fixed bearing and a second chassis bearing point which is designed as a floating bearing.

33. The industrial truck as recited in claim 27, wherein each of the at least two drive wheel arrangements further comprises a rotational drive motor which is coupled to the respective at least one drive wheel.

34. The industrial truck as recited in claim 33, wherein the rotational drive motor is arranged so as to be displaceable with the respective drive wheel arrangement along the linear path.

35. A drive wheel bearing device for an industrial truck, the drive wheel bearing device comprising:
a support structure comprising a first fastening region which is formed substantially in a plane, and a separate second fastening region which is arranged substantially perpendicular to the plane, the separate second fastening region comprising means for fastening the support structure to the chassis;
a wheel suspension structure which extends substantially perpendicular to the plane and which is rotatably mounted in relation to the support structure;
at least one drive wheel connected to the wheel suspension structure, the at least one drive wheel comprising a main axis of rotation which is substantially parallel to the plane; and
at least one drive motor configured to at least one of drive and pivot the at least one drive wheel in relation to the support structure.
